(19) United States
(12) Patent Application Publication
(10) Pub. No.: US 2018/0189382 A1
(43) Pub. Date: Jul. 5, 2018

(54) System for Forming Connections Between Users

(71) Applicant: Microsoft Technology Licensing, LLC, Redmond, WA (US)

(72) Inventor: David Mowatt, Dublin (IE)

(73) Assignee: Microsoft Technology Licensing, LLC, Redmond, WA (US)

(21) Appl. No.: 15/397,339

(22) Filed: Jan. 3, 2017

(51) Int. Cl. G06F 17/30

(52) U.S. Cl. CPC G06F 17/30675; G06F 17/30654; G06F 17/30867

(57) ABSTRACT

A system in which: in response to a question, answers and user profiles of multiple answering users are returned to the querying user in a form ranked according to respective feedback scores of the answering users. The system then receives a connection request from the querying user addressed to a selected one of the answering users, in order to request establishment of further contact between the querying user and the selected answering user. The system also receives a rating from the querying user in relation to the selected answering user. Furthermore, the system detects whether the further contact has been established between the querying user and the selected answering user following the forwarding of the connection request, wherein a contribution of the querying user's rating toward the respective feedback score of the selected answering user is dependent on the detection that further contact was established.

### BACKGROUND

Conferences and exhibitions offer great opportunities for promoting new products or services, as well as connecting with potential leads. In order to draw attention and attract footfall to their exhibition booths, exhibitors often give away promotional products, or run extravagant contests and stunts. These strategies do not guarantee quality leads as the visiting attendees are often not the prime target audiences. For example, they are likely to be mere passers-by who are only interested in the handouts but not the actual products or services the exhibitors are promoting. To make matters worse, the crowd amassed at the booths may put the potential leads or prime target audiences off from visiting because of the excessive waiting time needed to get to a representative at the booths.

As for the conference attendees, it too could be a daunting experience to seek the right exhibitors for solutions to their problems. They may have to visit many exhibitors at their booths and repeatedly go through the background information and the problems to each of the representative they encountered, before they can get to the right exhibitors who can satisfy their needs.

To facilitate the match-making process between the attendees and exhibitors, some exhibition venues provide means such as directories, display boards and online guides for communicating exhibitors' information and relevant statistics to the attendees. In some cases, forums in the form of physical message boards or online forums are provided for the attendees to submit their problems thereat, so that the exhibitors may take the initiative to contact the querying attendees. These message boards or forums are often categorised by industrial sectors, geographical locations, or types of problems, so to allow the exhibitors to identify potential leads more effectively.

### SUMMARY

The prior art method described above attempts to improve the efficacy of connecting exhibitors with the potential leads by listing the attendees' problems on a forum, in some cases in well-defined categories. However, the querying attendees are required to submit their identities and contact details along with the problems when posing onto said forum. Such contact details allow the exhibitors to follow up with the attendee or to send forward promotional materials, both during the conferences or after the conferences have finished. Unfortunately, such contact information is often abused. For example, querying attendees who posted on a forum may be bombarded with information they have no interests in, or may be cornered by sales reps who are only interested in selling irrelevant products that do not form an actual solution to the prescribed problems.

In addition, forum posts each describing the same underlying problem may be submitted by different querying users, and therefore different exhibitors may end up contacting each of the querying users with the same answer repetitively. This is not only highly inefficient, but the sheer quantity of repetitive problems posted onto the forum makes it difficult for exhibitors to identify and access any new problems that are submitted thereon.

Accordingly, the present disclosure provides a system that allows the querying attendees to distribute their questions to exhibitors, and thereafter provide feedback on the quality of solution an exhibitor provides once contact has been made. Such feedbacks, as well as the solutions offered by the exhibitors are displayable to other attendees. This prevents the abuse of contact information that commonly occurs in an ordinary forum system. E.g. exhibitors may receive negative feedback if their responses are unhelpful, used to sell services or products the attendee didn't ask for, or if the exhibitor regularly overpromises what they actually do.

However, there is an additional factor to consider, in that the feedback system itself will be vulnerable to abuse by malicious or unscrupulous parties. Particularly, an attendee may leave unduly negative feedback or unduly positive feedback despite having not in fact engaged with the exhibitor and therefore not being in a position to properly judge the quality of the proposition put forward by the exhibitor. Therefore, it would be desirable to provide a more secure feedback system. Accordingly, the present disclosure provides a mechanism whereby feedback is only earned once actual contact is made between an attendee and an exhibitor. This advantageously reduces the risk of undue attacks on a user profile, e.g. by competitors who may unscrupulously leave negative feedback if their identity is undisclosed.

Similar considerations may also apply in other scenarios where a querying user seeks input from another user and is able to leave feedback regarding that user.

According to one aspect disclosed herein there is provided a system comprising a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user. The system further comprises memory comprising one or more memory units, said memory storing code; and a processing apparatus comprising one or more processing units, said processing apparatus being arranged to run said code. The code is configured so as when run on the processing apparatus to perform operations of: receiving a question from a querying user; distributing the question to said plurality of users; in response to the question, receiving answers from multiple answering users from amongst said plurality of users; returning to the querying user the answers and user profiles of at least some of the answering users, wherein the returned answers and user profiles are returned to the querying user in a form ranked according to the respective feedback scores of the answering users; and receiving a connection request from the querying user addressed to a selected one of the answering users, and forwarding the connection request to the selected answering user in order to request establishment of further contact between the querying user and the selected answering user. Further, the code is configured so as when run on the processing apparatus to detect whether the further contact has been established between the querying user and the selected answering user following the forwarding of said connection request; to receive a rating from the querying user in relation to the selected answering user; and to make a contribution of the querying user's rating toward the respective feedback score of the selected answering user is dependent on the detection that said further contact was established.

Note that a “question” as defined herein can be any form of expression that is intended to invoke at least some of the answering users to respond with an answer. This may take the form of a written question (text), or an audio or video recording comprising a spoken question, or a question expressed in visual form such as by sign language or mime. The question may even take the form of another item of media such as a chart or table, an image, or a video. Note also that a question is not limited to a message with a question mark or raised inflection at the end, but could be any statement of need or desire of the querying user, e.g. a photo or drawing showing a problem the user would like to solve or a product he/she would like to buy.

Note also that a “user” as referred to herein does not necessarily have to refer to an individual person (though that is certainly one possibility). For instance, in some cases, the answering user may be a small party belonging to the same organization running a certain exhibit, concession, or the like.

In embodiments, the querying user's rating only contributes to the feedback score of the selected answering user on condition that said contact is detected to have been established. Alternatively, the querying user's rating contributes to the feedback score of the selected answering user with a weighting that depends on whether or not said contact is detected to have been established, the weighting being lower if said contact was not detected to have been established. In embodiments, the weighting may also be dependent on other factors such as the querying user's (e.g. attendee's) own rating score. For instance, a higher weighting may be given if the attendees have previously given evenly distributed rating scores to other exhibitors and thus can be seen as trusted reviewers, or if attendees have previously received good feedback from other attendees. The feedback may be dependent on a status of the selected answering user, e.g. to prioritise premium sponsors over other classes of exhibitor.

In embodiments, the system comprises one or more scanning devices, wherein said further contact comprises a physical meeting between the querying user and the selected answering user. In this case the detection that said further contact has been established comprises receiving an input from the one or more scanning devices confirming that one or both of: (a) the selected answering user has used one of the scanning devices to physically scan a physical user ID tag of the querying user, and/or (b) the querying user has used one of the scanning devices to physically scan a physical user ID tag of the selected answering user. E.g. the detection of the meeting may be based on a near field communication (NFC) technology.

Thus the present disclosure provides a method and system for distributing querying users' questions to other users such as exhibitors or the like, and any received responses from the answering are ranked based on their feedback score received from previous interactions. Because the feedback is conditional on detecting that the querying user and the answering user have actually met (in embodiments in person), then this mechanism adventurously secures the feedback process against a degree of abuse.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of the system according to an embodiment of the present invention,

FIG. 2 is a block diagram of the system according to the embodiment illustrated in FIG. 1,

FIGS. 3a and 3b are examples of a prior art registration interface,

FIG. 4 is a process flow chart for connecting attendees with exhibitors according to an embodiment of the present disclosure,

FIGS. 5a, 5b, 5c, 5d, and 5e are examples of a querying interface according to an embodiment of the present disclosure,

FIGS. 6a, 6b, 6c, and 6d are examples of a ranked list of answers according to an embodiment of the present disclosure,

FIGS. 7a and 7b are examples of a feedback interface according to an embodiment of the present disclosure, and

FIGS. 8a and 8b are examples of a question list according to an embodiment of the present disclosure.

### DETAILED DESCRIPTION OF EMBODIMENTS

The present invention comprises a system to provide a ranked list of exhibitors who can solve a conference attendee's exact problem, where ranking is informed by other attendees scoring how well the exhibitor solved their similar problem. In some cases, this is done in a way that does not reveal the attendee's identity up front.

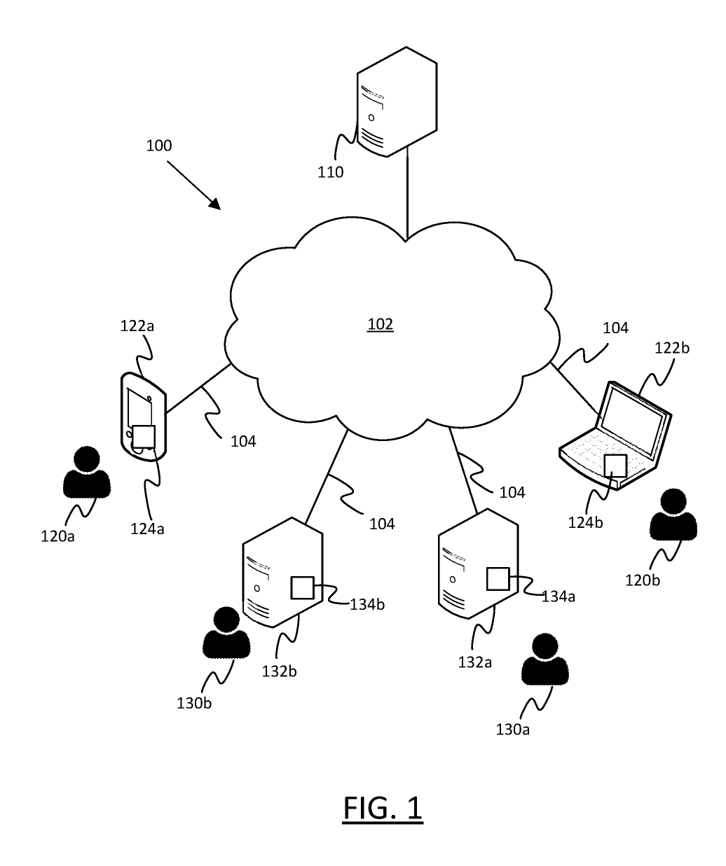

FIG. 1 schematically illustrates a system 100 in accordance with embodiments disclosed herein. The system comprises a server 110 being configured to connect to computer network 102 for communicating with user terminals 122a,b, 132a,b each accessible by a respective user 120a,b, 130a,b. In the illustrated example, the users 120a,b, 130a,b comprise conference attendees 120a,b and exhibitors 130a,b. A conference attendees 120a,b refer to someone who attends a conference (or exhibition) and seeks solutions for one or more problems, whereas as an exhibitor 130a,b is a company or a trader who has setup a booth at said conference to promote products and/or services on offer. The system 100 is not limited to conferences, but it also finds use in other applications, for example online forums engaging local trade with customers. In FIG. 1, four users 120a,b, 130a,b are shown for illustrative purposes, but it will be appreciated that there may be different numbers of attendees 120 and exhibitors 130 involved in other scenarios covered by the present disclosure. In some cases, a user can be both an exhibitor 130a,b and an attendee 120a,b.

The network 102 is preferably a packet-based network. In embodiments, it may take the form of a wide-area internetwork such as that commonly referred to as the Internet. Alternatively, the network 102 may take the form of another type of network such as an intranet provided at the conference venue. Each of one or more of the user terminals 122a,b, 132a,b may be connected to the main network 102 via a client side network 104, for example, a mobile cellular network, or a wireless local area network (WLAN), or a combination of any of these.

The server 110 is connected to the network (e.g. Internet) 102, and is arranged to serve the user terminal(s) 122a,b, 132a,b via the network 102. The server 110 is tasked with three main functions: to receive questions from attendees 120a,b for distributing to exhibitors 130a,b; to manage contact between the attendees 120a,b and exhibitors 130a,b; and to maintain a feedback score for each of the exhibitors 130a,b based on the answer and service provided to the attendees 120a,b. Note that a server as referred to herein may comprise one or more physical server units located at one or more geographic sites (distributed storage and processing techniques in themselves being known in the art).

Each of the user terminals 122a,b, 132a,b may take any of a variety of different forms, such as a desktop computer, laptop, tablet, smartphone, smart watch, pair of smart glasses, smart TV, set-top box, or conference room phone unit (and the different user terminals 122a,b, 132a,b need not necessarily take the same form as one another). Note therefore that the term “computer” as used herein does not restrict to a traditional desktop or laptop computer.

Client applications 124a,b, 134a,b are each installed on computer-readable storage of their respective user terminal 122a,b, 132a,b, and arranged for execution on a respective processing apparatus of the respective user terminal 122a,b, 132a,b. The storage may take the form of one or more storage media (e.g. magnetic memory, electronic memory, and/or optical memory) implemented in one or more memory units. The processing apparatus may take the form of one or more processing units. Each of the client applications 124a,b, 134a,b is configured so as to be able to communicate with the server 110 via the network 102 (and in embodiments via the respective local network) in order to access the contents of forum hosted thereat.

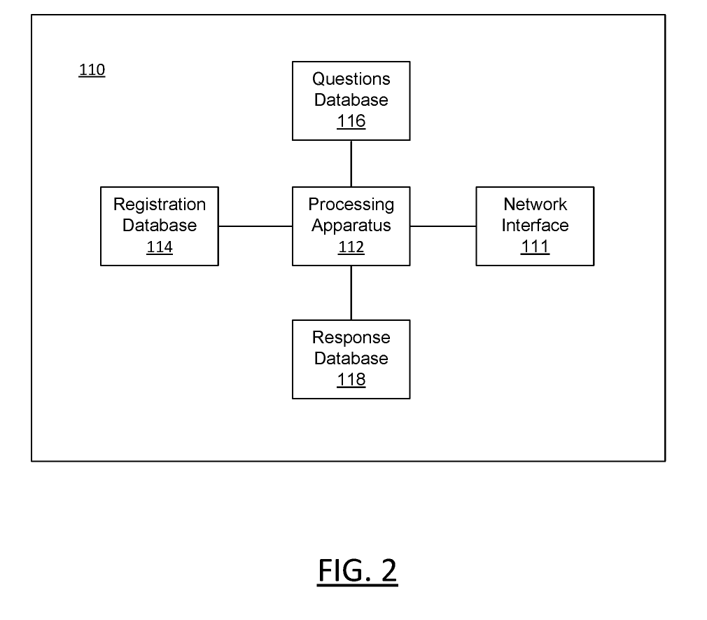

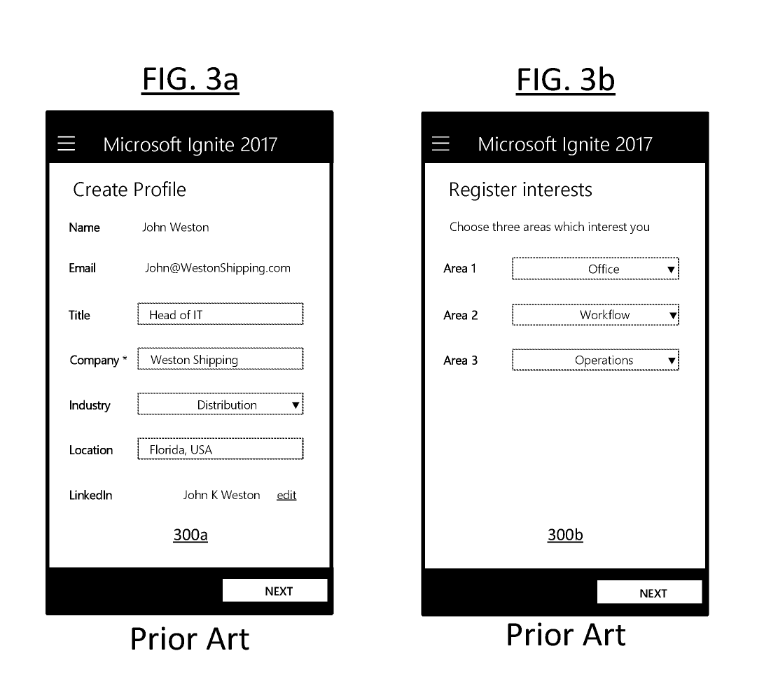

FIG. 2 is a block diagram illustrating the main components in the server 110. As shown in FIG. 2, the server 110 comprises a network interface 111, registration database 114, questions database 116, and response database 118 in connection with a processing apparatus 112. The network interface 111 provides an interface for the server 110 to connect with the user terminals 122a,b, 132a,b via the packet based network 102. The registration database 114 stores the user profiles of registered users, e.g. the attendees and exhibitors, wherein said user profiles are provided by the user during a registration process and readily accessible by the processing apparatus 112. Each of the user profiles is assigned with a unique identity (ID), e.g. attendee ID or exhibitor ID, that does not disclose the identity of the user. As shown in FIGS. 3a and 3b, a prior art registration interface 300a or 300b is provided on the user terminals 122a,b, 132a,b for inputting contact details (e.g. name, title, email addresses, and phone number) and user information (e.g. role, industry, geographical location, expertise, and interest) of the users. In some embodiments, different registration interfaces 300 may be provided for attendees and exhibitors so to gather role specific information, for example a registration interface for exhibitors may comprise additional fields to specify the technical advice an exhibitor is able to offer or to provide a brief introduction to the exhibitor. Said user information aids exhibitors to identify potential leads such that they can selectively provide answers to attendees who share certain traits. For example, based on the user information of the querying users and the exhibitors, the questions may be ordered in a ranked list according to relevance in industry or technical area.

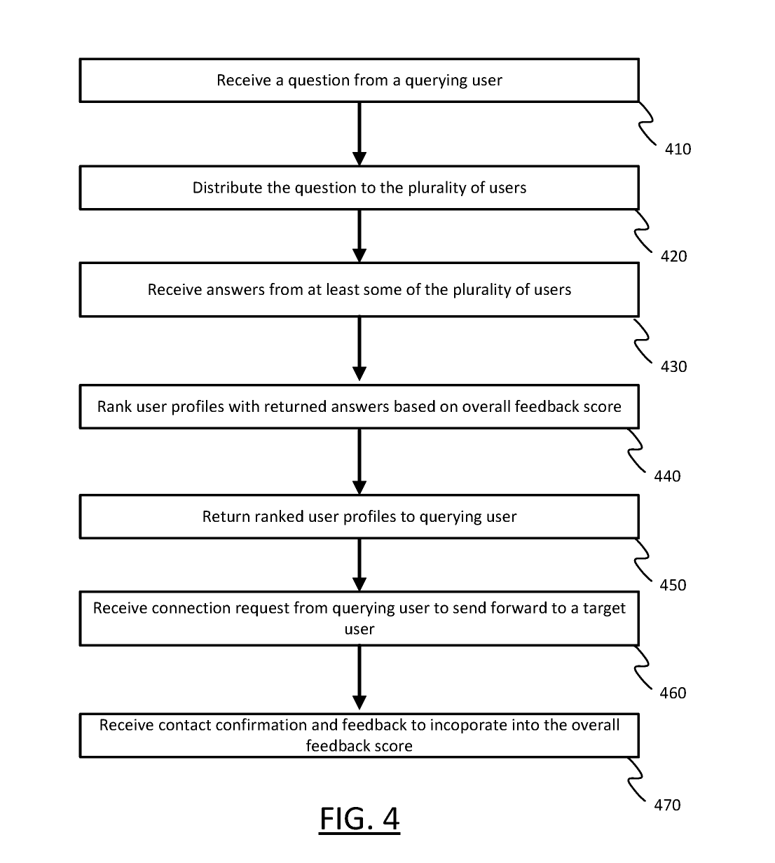

The method of performing the present invention can be summarised in the steps shown in FIG. 4. Starting at step 410, the server 110 receives a question from a querying user, e.g. attendees 120a,b to a conference, and thereby based on the nature of the question and/or user profiles step 420 ranks the questions to be displayed to other users, e.g. exhibitors, according to their suitability. In some embodiments, a query interface is provided by the client applications 124a,b installed on the user terminals 122a,b for the querying users for inputting questions to be distributed to suitable exhibitor. Said client applications 124a,b may then forward the inputted questions from the user terminals 122a,b to the server 110, and to be stored at the questions database 116.

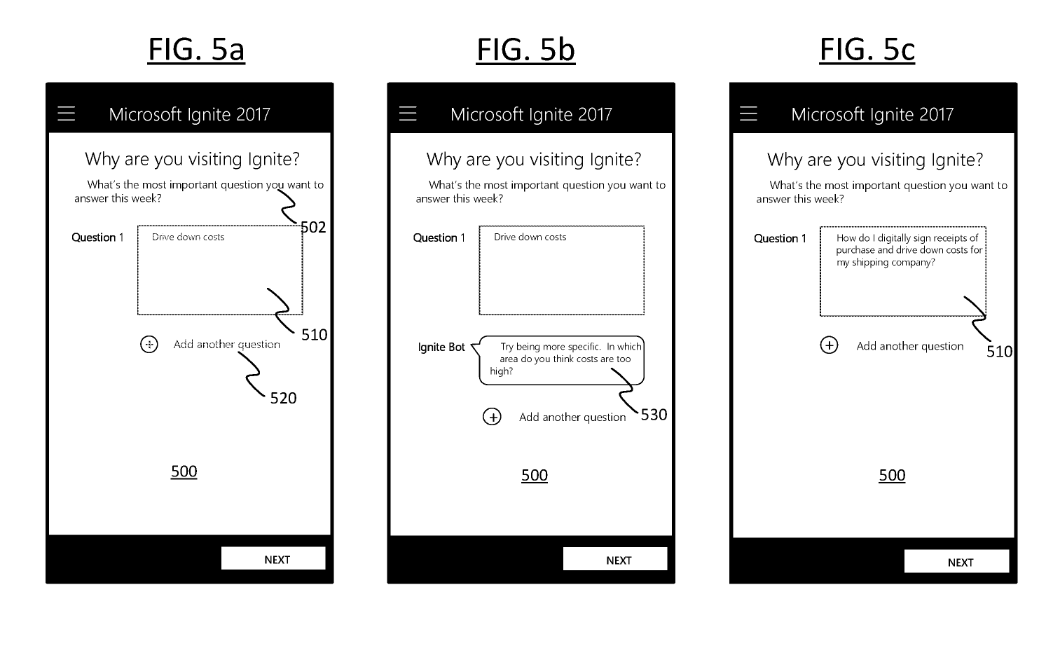

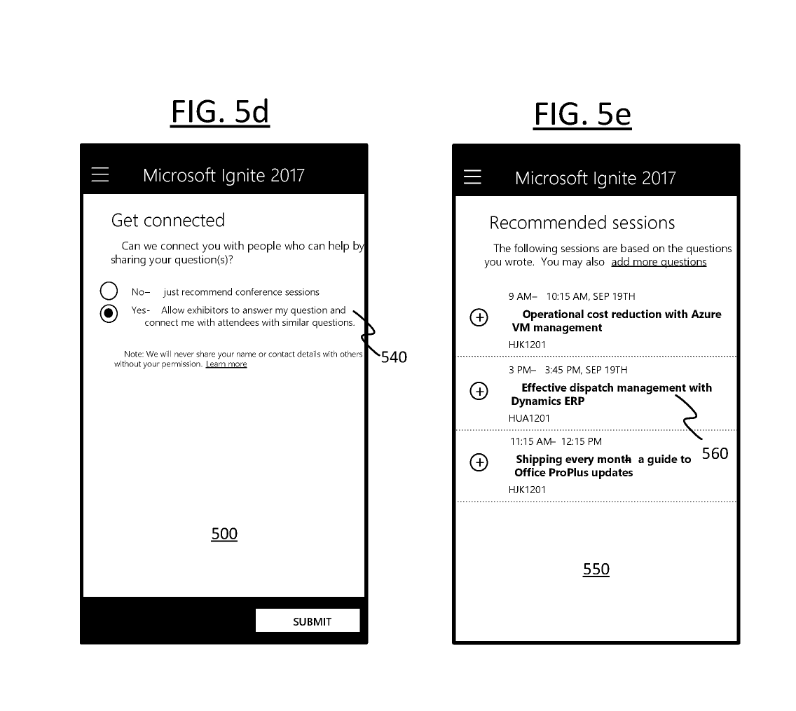

FIGS. 5a,b,c shows an example of query interface 500 provided on the commutation clients 124a,b. In FIG. 5a, a querying user inputs a question “Drive down costs” into text box 510 in response to instructions 502 “What's the most important question you want to answer this week?” in the query interface 500. The instructions 502 prompt the users 102a,b to input a question and may be a default instruction or editable by a conference organiser. The query interface 500 further provides a selectable option 520 for the querying user to provide additional questions. For example, an additional question “Improve efficiency” may be asked in addition to “Drive down costs”, wherein the plurality of questions may be processed separately or in combination with each other.

The inputted questions are stored at the question database 116 along with the user ID of the querying user. The stored questions are then analysed to determine their nature, e.g. based on textual analysis techniques such as word count, keyword extraction/identification, domain classification, and/or natural language processing (NLP). Based on this analysis, the processing apparatus 112 identifies how one or both of: (i) which exhibitors 130a,b each question is to be distributed to and/or (ii) how the questions are ranked when they are displayed to each of the exhibitors 130a,b. For instance, text matching may be used to extract one or more keywords in a question, or NLP may be used to extract one or more indications of intent in the question, and these keywords or intentions may be compared against the exhibitors' profiles to determine which exhibitors are most relevant to the question.

In some cases, as shown in FIG. 5b, the processing apparatus 112 determines that the question “Drive down costs” posted by the querying user does not carry sufficient information, or the question covers a very broad technical area so that a meaningful search for suitable exhibitors cannot be achieved. I.e. the question needs to be more specific. Therefore, a second prompt 530 is displayed on the querying interface to prompt the querying user to provide a more specific question. As a result, the querying user re-enters a more specific question in the text box 510 in FIG. 5c, so to limit the technical area it covers. The processing apparatus 112 then processes the new specific question and identifies the relevant technical areas, before distributing the question to exhibitors operating in said technical areas.

In some embodiments, the processing apparatus 112 may analyse the querying user's question(s) and recommend suitable conference sessions to the querying user. For example, the processing apparatus 112 may base its recommendations on identified keywords in the summary of conference sessions, or the recommendations may be based on the interest or attendance of other attendees who have raised similar question or having a matching profile to the querying user. Alternatively or additionally, the question(s) may be sent to one or more information retrieval services such as databases and/or search engines to identify and retrieve relevant articles therefrom, e.g. recommended help articles, blogs, and/or other documents.

In some embodiments, the querying interface 500 provides options 540 for the querying users to authorise distribution of question to exhibitors 130a,b and/or to receive recommendations to suitable conference sessions, as shown in FIG. 5d. The latter allows the querying users to keep information embedded in the questions hidden from the exhibitors, yet still directs the querying user to suitable conference sessions where it is likely that the querying user may find answers to their questions. Suitable conference sessions may be determined by the textual similarity in their keywords, abstracts, summaries with the submitted questions, or the querying users' user profiles. In embodiments, the results may be ranked by said textual similarities. Those skilled in the art of information retrieval will be aware of various existing algorithmic approaches suitable for optimising ranking depending on specific data or metadata. A ranked list of recommended conference sessions 550 can then be displayed to the querying users, where each of the entries 560 in the recommended sessions list 550 comprises the time, location, and title of a suitable conference session, as shown in FIG. 5e. The querying user may add the suitable conference sessions to his/her electronic diary so that reminders can be set up for each of the sessions.

Each of the exhibitors may access a personalised ranked list of questions on their respective client applications 134a,b as installed on their user terminals 132a,b. Each of the question in the list comprises attendees' user ID, and optionally their title, location, and industry, etc. In some embodiments, the identity and contact details of attendees are not provided with the question such that the identity of the querying users remains anonymous. In some embodiments, the ranking of questions in the list is based on analysing word-level similarity between a given question and the records of other questions that the exhibitor had previously responded in the response database 118, and/or the similarity between the nature of questions (e.g. based on NLP). Alternatively or additionally, the ranking may be based on a word-level or NLP-based similarity between the querying user's profile and the exhibitor's user profile.

In some embodiments, the questions from querying users are only distributed to exhibitors 130a,b who are capable of answering said questions or having user profiles relevant to the questions and/or querying users. For example, once the context of the question is analysed textually and keywords are extracted therefrom, the processing apparatus 112 then searches the registration database 114 to identify any suitable exhibitors having a user profile that matches the keywords, and therefrom dispatches the questions to said suitable exhibitors. Or a similar process could be performed using NLP-based techniques to identify suitability. The exhibitors who are deemed not relevant, e.g. whose user profiles do not contain any of the keywords, are excluded from the distribution list. Alternatively, the questions may only be sent to exhibitors who share similar user profiles to the querying users, e.g. the exhibitors having similar background to or operate in the same technical field as the querying users are more likely to be able to answer the questions. This method ensures that only the relevant questions are received by exhibitors, thus enabling the exhibitors to assess the list of question in a more efficient manner.

In some embodiments, the system may not send the questions to all exhibitors at once. For example, the processing apparatus 112 may prioritise the sending of the question to certain exhibitors based on one or more parameters such as their overall score, suitability according to the above mentioned NLP techniques, and/or their status (e.g. wither the exhibitor is a sponsor, or a level of sponsorship such as whether they are a gold exhibitor). The prioritised exhibitors may receive the question sooner than non-prioritised exhibitors so that they have a head start in responding to the question(s). As another example, sensor feedback at a given exhibitor's booth (e.g. badges scanned, or web cam detecting people/movement) may determine that a particular booth is too busy, for example the exhibitor is occupied and therefore cannot accommodate other attendees. The processing apparatus 112 to may be arranged to receive this sensor feedback and in response to impose a delay in sending forward the question to said occupied exhibitor, or to withhold the exhibitor's response to the attendees until the exhibitor is free again. Similar priorities may be given to exhibitors having little or no footfall.

In some embodiments, the processing apparatus is equipped with machine learning capabilities such that the accuracy of match between questions and their relevance to the exhibitors may improve over time. This may be achieved by monitoring the questions exhibitors have previously responded to, as well as gathering feedback directly from the exhibitors.

In response to the questions, some exhibitors submit (at step 430) their answers to the response database 118 at the server 110, which are then stored thereat. The answers may be in the form of a text message which they can personalize to the particular question that was asked, e.g. a summary showing how their products or services can solve a prescribed problem. Each of the answers provided by an exhibitor may then be scored by the querying user, wherein said score contributes to an overall score stored for said exhibitor in the registration database 114.

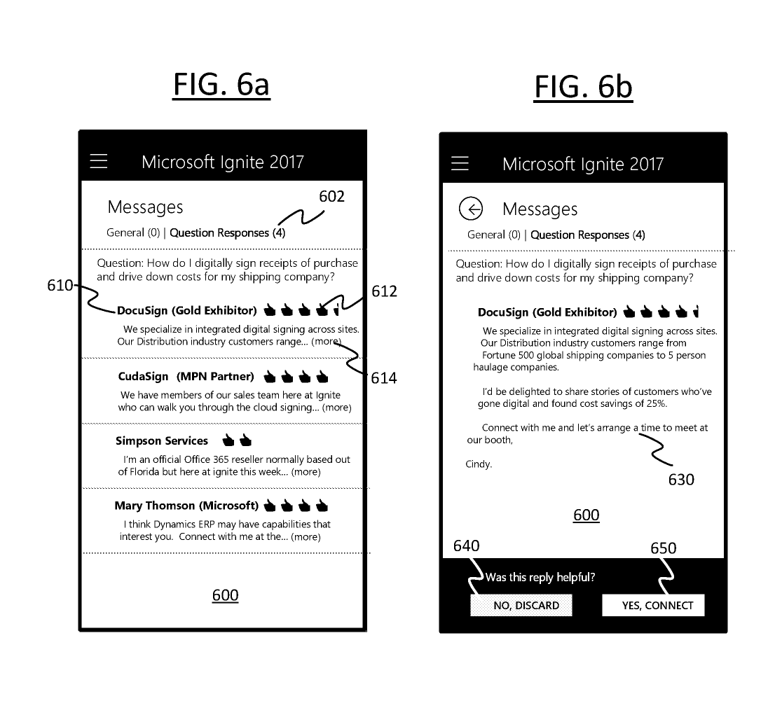

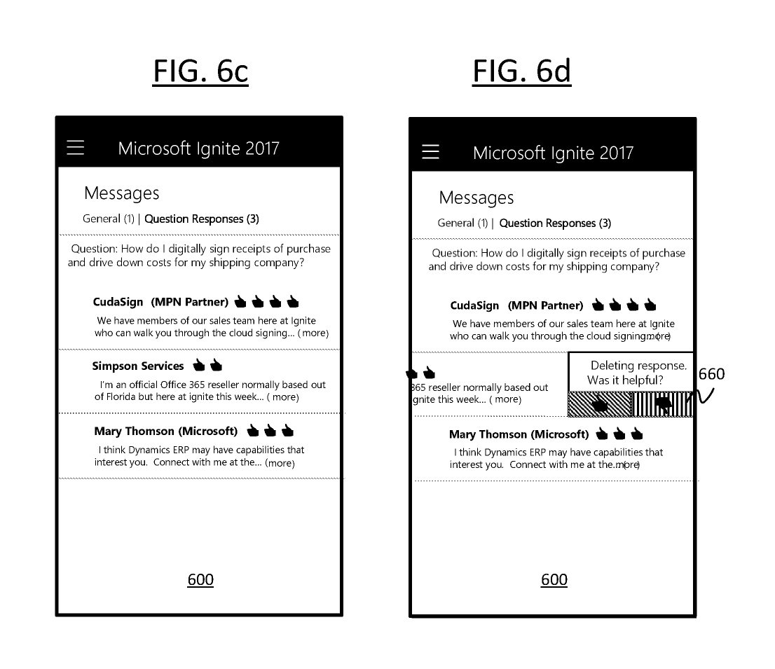

Based on their respective overall score, the server 110 may rank (at step 440) the user profiles of exhibitors and therefrom compile a ranked list of answers to send forward (at step 450) to the querying user, so to enable said querying user to initiate a connection request (at step 460) to a target user or target exhibition from the ranked list to establish contact, e.g. a physical (i.e. in-person) meeting to further elaborate upon the answer. An example of a list of answers is shown in FIG. 6a, where the querying users are provided with a notification in their commutation clients 124a,b indicating the number of answers 602 received for their questions. On the ranked list of answers shown in FIG. 6a, an abstract from each of the answers 614 is displayed, along with the identity 610 and a displayed score 612. The abstract of each of the listed answers may be the first few sentences of the answer, or keywords contained in said answer.

The answers are ranked by displayed score 612, which may be an overall score 612 recorded against the exhibitors in their user profiles, or the display score 612 may be the estimated score that is specific to the question, or a combination of overall score and estimated score. In some embodiments, the overall score of a user profile may be raised if the respective user has an elevated standard, e.g. the use is a conference organiser or a gold partner. This improves the prominence of said users. In some embodiments, the displayed score is time sensitive. For example, a recently submitted answer may be awarded with a high initial score but subject to gradual reduction with time, as a result any new answers provided to the querying user are displayed more prominently.

An example is given in FIG. 6a, the exhibitor “DocuSign” has achieved a 4.5 stars rating, which may be attributed to the gold exhibitor status, quality of answers provided to other users, relevance, or the timeliness of the answer. Because of the ranking, a partial display of answer provided by “DocuSign” has occupied the top spot of the ranked list. By selecting said answer, a querying user may inspect the full answer 630 in an expanded display in FIG. 6b. Based on the answer 630 the querying user may opt to discard the message 640 or to send a connection request 650 to the selected exhibitors so to follow up on the answer. Either way, the querying user will be directed back to the ranked list of answers 600 of FIG. 6c to inspect answers provided by other exhibitors.

In some embodiments, the overall score of exhibitors' profiles may be dependent on one or more additional factors. For instance, the weighting may be higher if the answering user is attributed an elevated status by the system, e.g. they are a sponsor or a gold sponsor of the conference. As another example, the score may be raised if said exhibitors have not been receiving many visitors, causing their responses to rank higher among the other exhibitors. This helps distributing the attendees evenly among the exhibitors.

In some embodiments, the querying user may provide a negative rating based on a poor quality answers or spam received from an exhibitor. For example, as shown in FIG. 6c and FIG. 6d, the querying user reads the abstract of an answer sent forward by exhibitor “Simpson Services”. In this example the abstract does not indicate a solution directed to the question, and as a result the querying user recognises the answer as a spam message and thereby selects the button 660 to delete message and to provide a negative feedback. Such negative feedback reduces the overall feedback score against the user profile of exhibitor “Simpson Services”. The feedback system is considered to be an effective deterrent against spam messages and advertisement, as well as low quality answers.

Once a querying user sends a connection invitation to an exhibitor, i.e. a target exhibitor or target user, he/she discloses his/her previously anonymous identity and contact information to the target exhibitor with said invitation, such that contact between the two parties can be established. Thus there is provided a mechanism of “progressive disclosure”, whereby the querying user only discloses information about him/herself in stages, only disclosing his/her actual identity (i.e. person identity details) once the answering user has provided a response that satisfies the querying user that he/she would like to establish further contact. This advantageously helps guard against spam from unwanted exhibitors or the like. The subsequent contact can be a physical face-to-face meeting or it can be an online instant messaging session. Either way, the querying user gains further knowledge on the products and services offered by the target exhibitor through said contact.

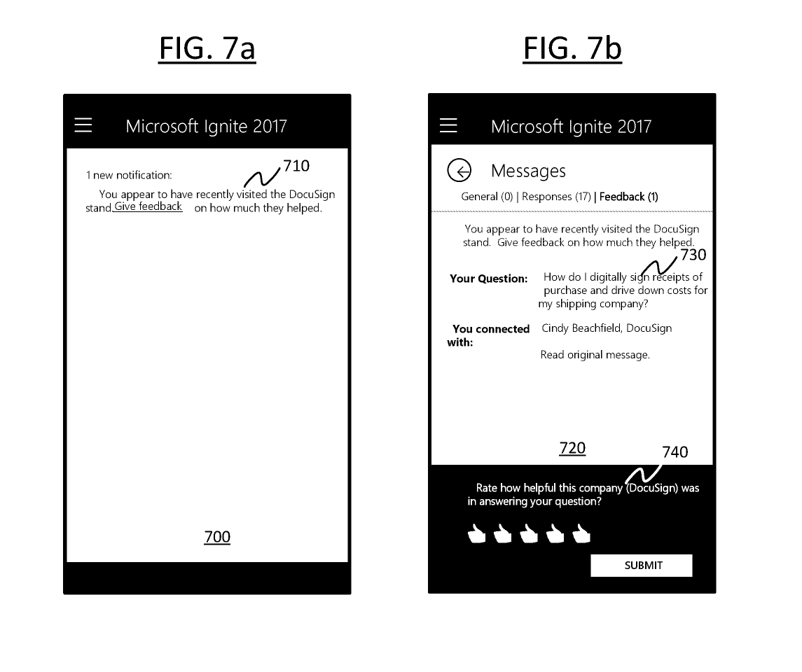

The server 110 receives a confirmation once contact is established between the querying user and the target exhibitor, and recognizes that the target exhibitor had previously provided an answer to the querying user. The server 110 then sends a notification 710 to the client application 124a,b of the user device 122a,b to notify the querying user 120a,b that feedback can be left based on the quality of answer provided by the target user 130a,b, as shown in FIG. 7a. The querying user 120a,b will then be directed to a feedback interface 720 as shown in FIG. 7b, where a summary 730 is provided to confirm the details with the querying user, as well as a scoring tool 740. The querying user may, for example, select a graphical representation of rating (e.g. the number of thumbs) or input a numerical score (e.g. percentage) in order to rate the answer received.

Thus in embodiments, only ratings from querying users who made contact with the target user may count towards the overall rating score.

In some variants of this, a confirmation of contact is only necessary for registering a positive feedback given by the querying user when rating the target user, e.g. the querying user may rate the quality of answer provided or how likely he/she will recommend the target user to other attendees; whereas negative feedback may be left irrespective of whether the querying user is confirmed to have met or engaged with the attendee or answering user. This advantageously helps reduce spam from unscrupulous exhibitors or such like leaving answer to questions to which they have little relevance. For instance, positive feedback may be considered any score greater than a predetermined threshold score within the range of possible feedback scores, whereas negative feedback may be any score below the threshold (and if the score is exactly the threshold, this could be considered positive or negative depending on implementation). E.g. if the querying user can leave a score between minus and positive twenty then anything above zero could be positive whilst anything below zero could be negative. Or if the querying user can leave feedback anywhere from zero to five stars, then two-and-a-half starts may be the threshold for positivity. As another example, qualitative feedback options may be provided, e.g. “good”, “poor”, “fair”, which the processing apparatus 112 translates into quantitative scores.

In further variants, feedback can be left whether the users have made contact or not, but ratings from uses who made contact are given a much higher weight than ratings from users who did not make contact.

In embodiments, feedback may be given and registered by the querying user based on the answer 630 received in the list of answers 600. Once a confirmation of contact is received the feedback is enhanced so to encourage the exhibitors to accept the connection request issued by the querying user. For example, an exhibitor may have received a five star rating instead of a four star rating if said exhibitor attends a meeting with the querying user to further elaborate a given answer 630.

In embodiments, where the contact is a physical (i.e. in-person) meeting, the confirmation of contact may for example be attained when the querying user scans his/her ID badge at the target exhibitor's exhibition booth. More specifically, the querying user meets the target exhibitor, he/she is required to present the ID badge to said target exhibitor's user terminal 132a,b for scanning and recording his/her contact details. The client application 134 as installed on the target exhibitor's user terminal 132a,b then sends a confirmation to the server 110 to confirm that contact has been made between the two parties. Alternatively or additionally, the exhibitor could be required to present an ID badge to be scanned by the terminal 122 of the querying user, and the client 124 thereon sends confirmation to the server 110 to confirm that the contact has been made.

The scanning of the badge may be based on any near field communication (NFC) technology, such as a radio frequency (RF) ID tag embedded in the badge, to be scanned by an RF ID tag reader in the other user's terminal 132a,b, 122a,b. Other NFC technologies are also known to the skilled person. As another example, the badge may comprise another kind of tag in the form of a 1D or 2D barcode (e.g. a quick response (QR) code) which is scanned by a camera on-board the other user's terminal 132a,b, 122a,b. Also, more generally, the tag could be implemented in any form, not necessarily just in a badge. For instance, the RF tag or QR code could be included in an item of clothing, or in a card (e.g. the size of a credit card) to be presented by hand. Further, the scanning device need not be the user terminal 132a,b, 122a,b of the other user, but could be another device such as a dedicated barcode reader.

In general, the physical meeting of the users may be detected by any means known to the person skilled in the art for detecting physical presence of a user. For example, the meeting may be confirmed using one or more biometric scanning devices (e.g. configured to verify the presence of a user based on facial recognition, fingerprint recognition, and/or iris recognition); or a code-inputting based system where the attendees manually input a user specific code into a device physically located at the target exhibitor's booth. In another alternative example, the confirmation of contact may be attained by having the attendees' phones wirelessly paired with each other via a range-limited wireless access technology such as Bluetooth or ZigBee, or by having their phones scan a code displayed on each other's phones. In yet another alternative or additional example, the confirmation of contact may be attained by detecting a close proximity between the attendees' phones using any known positioning means, such as those that operate by triangulation, trilateration, multilateration, and/or fingerprinting based on signals transmitted between a mobile device about the user's person and a plurality of wireless reference nodes (for example satellites in the case of a satellite navigation system, or anchor nodes of an indoor positioning network, or wireless nodes that happen to be present in the environment already such as Wi-Fi access points). Any such option minimises malicious or unscrupulous manipulation of the rating system because the parties have to physically meet with each other in order to provide ratings for each other.

Whatever implementation is used, it is thus confirmed that the querying user is within a predetermined physical proximity of the scanning device used by the selected answering user, or that the selected answering user is within a predetermined proximity of the scanning device of the querying user. The system is therefore able to verify whether the two users have physically met, i.e. face-to-face, at the same location at the same venue (e.g. same room or booth); and to make the leaving of feedback dependent on whether or not this physical meeting is verified.

In alternative embodiments, the contact between the users is a virtual meeting such as a VoIP call, video call, or an instant messenger meeting. In such cases, the confirmation of contact may be sent from the client application 134 on target exhibitor's user terminal 132 (and/or from the client 124 on the attendee's terminal 122) once the VoIP or IM session has started. Such a virtual meeting may take place during the conference, or after the conference where ratings would retrospectively contribute to the overall rating score of the target exhibitor, to be used in subsequent conferences.

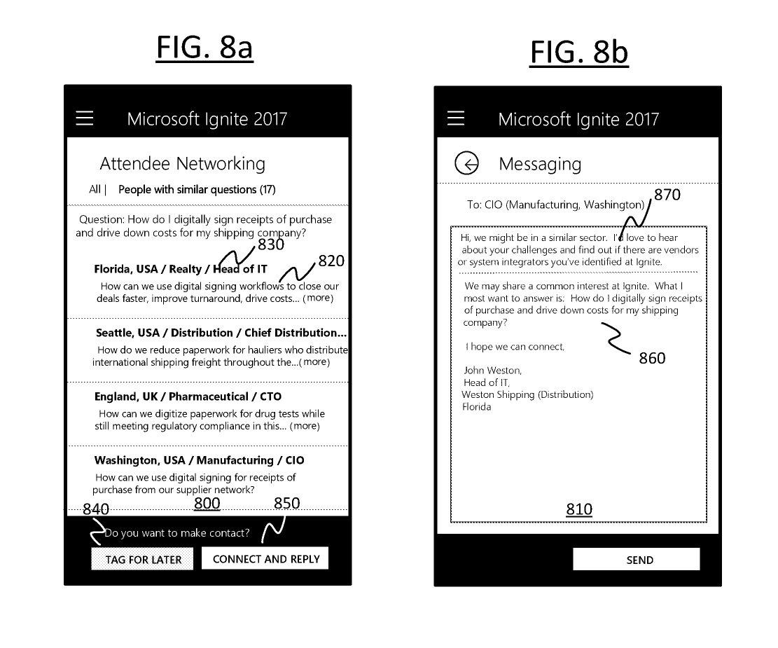

In further alternative or additional embodiments, a conference attendee 120a may review other attendees' 120b questions to identify users from other organisations who face similar problems. In this case, the server 110 searches the question database 116 to identify similar questions posted by other attendees. The search may be based on the described textual similarity match, e.g. word-level similarity between a given question and the records of other questions in the questions database 116, and/or the search may be based on such similarities in their user profiles. Based thereon, the server 110 then compiles a list of question 800 to be displayed at the client application 122a for the querying user, as shown in FIG. 8a. Other tests for similarity could also be applied, such as based on NLP.

The question list 800 may be ranked according the questions' similarities with the question posted by the querying users 120a so that the querying users may reference to answers previously provided by target exhibitors 130, and therefrom send forward a connection request to said target exhibitors 130 to establish contact. Alternatively, the question list 800 may be ranked according to their similarities in user profiles to the querying users, such that the querying users may seek answers to other problems commonly encountered by users from a similar field.

Unlike the list of answers 600 which displays the exhibitors' name with the answers, the identities of other attendees who have previously submitted to the question list 800 are kept anonymous. As shown in FIG. 8a, each of the entries in the question list 800 provides user information, such as geographical location, job title, and industry, in the message header 830 to be displayed with an abstract of the question 820. Said abstract of questions can be the first few words of each of the questions, or can be keywords related to the questions submitted by the querying user.

In some embodiments, this ranking is carried out dynamically. In others, the ranking of question list are created at runtime, and therefore the ranked list displayed on querying user's client application 124a,b is updated only when another attendees add/remove submitted questions, e.g. when a new question is added to the question database 116, an asynchronous process determines how it compares to the other questions already in the system. This repeats as new questions are added to/removed from the question database 116 by other attendees.

As shown in FIG. 8a, once the querying user recognises a target user/target attendee on the question list 800 whom he/she would like to establish contact with, he/she may select “tag for later” button 840 to bookmark said target attendees on the question list so to allow him/her to establish contact later, or the querying user may send a connection invitation to the target attendee by selecting the “connect and reply” button 850 and be transferred to an invitation interface 810 as shown in FIG. 8b.

Some querying users may prefer to send a connection invitation to a number of target users. To facilitate the invitation process, an invitation template 870 is provided by default at the invitation interface 810, which identifies the querying user and his/her user information extracted from the user profile in the registration database 114, as well as the questions the querying user has submitted. Additionally, a personalised message 860 can be inserted to the connection invitation such that the querying user can tailor the message to send forward to the target attendee for establishing contact. An established contact may be a physical meeting, or an online messenger session between the querying user and the target attendee. In both cases, the querying user and the target attendees may confirm, via their respective client applications 124a,b, to the server 110 that the contact has been made.

In some embodiments, each of the attendees is also assigned with an overall feedback score similar to that provided for the exhibitors. An attendee with an above average feedback score attracts attention and therefore his/her connection invitations are more likely to be accepted by exhibitors and other attendees. This discourages timewasting behaviours and encourages active participation of the attendees. For example, both the querying user and the target attendee may be provided with a scoring tool 740 by the server 110 to rate the assistance provided by each other, once the server 110 has received confirmation that a contact is made between the two parties. The score received for the querying user and the target attendee contributes to their respective overall feedback score.

As mentioned, in some embodiments, the server 110 may accept negative ratings from the querying users, target exhibitors, and target attendees without a confirmation of contact; e.g. to discourage spam advertisement and/or no-shows where no confirmation of contact would be generated. In some cases, the conference organisers may manually apply negative ratings to the overall feedback scores of misbehaving users. For example, an exhibitor may file a complaint with the conference organiser for a querying user who displays abusive behaviour at the exhibitor's booth, and thus resulting a negative rating being applied to the querying user's overall profile score, even if no confirmation of contact was received by the server 110. With a lowered overall profile score, future connection requests from an abusive exhibitor are more unlikely to be accepted by attendees.

In further alternative or additional embodiments, the feedback given by an attendee (or more generally querying user) may be automatically weighted based on one or more additional factors. For instance, one such factor may be the attendee's own rating score. E.g. have they given evenly distributed rating scores to other exhibitors, or have they been rated as reliable when answering the questions of other users? If so, the attendee's feedback ratings may be trusted more than that of an attendee who him/herself has a low rating. As another alternative or additional example, the weighting may depend on a status of the exhibitor (or more generally answering user). For instance, the system may record a status as sponsor associated with a particular exhibitor, or a particular level of sponsorship such as gold or silver, etc.; and the weighting applied to the feedback given to the exhibitor in question may depended on their status such as whether they are a sponsor and./or the level of sponsorship. Thus the feedback received for exhibitors or gold exhibitors, for example, may accumulate a higher overall score faster than ordinary exhibitors.

As yet another alternative or additional embodiment, the booth or exhibit of one or more of the exhibitors (or more generally any such location at which one or more answering users are station) may be equipped with a respective one or more presence sensors for detecting the presence of people within a predetermined proximity of that location. For instance, such a presence sensor may take the form of a passive infrared sensor, active ultrasound sensor, or vision sensor (camera plus image recognition algorithm). The processing apparatus of the system may be configured to receive presence sensor results indicative of a degree of footfall at the respective location based on the presence sensed by the presence sensor(s), and to adapt the weighting in dependence on this. E.g. this could be configured to give a greater weighting to exhibitors who have a lower footfall so as to more evenly distribute the attendees throughout the venue. Or alternatively a greater weighting could be given to those with a higher footfall on the basis that this provides an indication of the popularity of a certain exhibitor.

It will be appreciated that the above embodiments have been described by way of example only.

More generally, according to one aspect of the present disclosure, there is provided a system comprising: a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user; memory comprising one or more memory units, said memory storing code; a processing apparatus comprising one or more processing units, said processing apparatus being arranged to run said code; wherein the code is configured so as when run on the processing apparatus to perform operations of: receiving a question from a querying user; distributing the question to a set of some or all of said plurality of users; in response to the question, receiving answers from multiple answering users from amongst said set of users; returning to the querying user the answers and user profiles of at least some of the answering users, wherein the returned answers and user profiles are returned to the querying user in a form ranked according to the respective feedback scores of the answering users; receiving a connection request from the querying user addressed to a selected one of the answering users, and forwarding the connection request to the selected answering user in order to request establishment of further contact between the querying user and the selected answering user; detecting whether the further contact has been established between the querying user and the selected answering user following the forwarding of said connection request; and receiving a rating from the querying user in relation to the selected answering user; wherein a contribution of the querying user's rating toward the respective feedback score of the selected answering user is dependent on the detection that said further contact was established.

In embodiments, the system may comprise one or more proximity detection devices for detecting proximity between users, wherein said further contact may comprise a physical meeting between the querying user and the selected answering user, and wherein the detection that said further contact has been established may comprise receiving an input from the one or more proximity detection devices confirming that the querying user has come within a predetermined proximity of a location of the selected answering user or vice versa.

For example, the one or more proximity detection devices may comprise at least one near-field communication device configured to detect said proximity based on a near field communication technology. In another example, the one or more proximity devices may comprise at least one RF reader configured to detect said proximity based on reading an RF tag. In another example, the one or more proximity devices may comprise at least one barcode scanning device configured to detect said proximity based on scanning a 1D or 2D barcode. In another example the one or more proximity devices may comprise at least one biometric scanner configured to detect said proximity based on scanning at least one biometric feature of the querying user or selected answering user. In another example, the one or more proximity devices may comprise at least one manual user input device configured to detect said proximity based on the querying user or selected answering user having to manually input a code at the manual user input device. In yet another example, the one or more proximity devices may comprise at least one mobile device configured to detect said proximity based on detecting a location of the mobile device relative to a network of wireless reference nodes. A combination of any two or more such techniques could also be used.

In alternative embodiments, said further contact may comprise a virtual meeting, and said detection may be performed by acquiring digital signatures from the querying user and/or the target user. For instance, the virtual meeting may comprise a voice or video call, and said detection may comprise detecting that the voice or video call has been established.

In embodiments, the contribution of the rating to the respective feedback score of the selected answering user may be dependent on the detection that said contact was established in that: the rating only contributes to the feedback score of the selected answering user on condition that said contact is detected to have been established.

Alternatively, the contribution of the rating to the respective feedback score of the selected answering user may be dependent on the detection that said contact was established in that: the rating contributes to the feedback score of the selected answering user with a weighting that depends on whether or not said contact is detected to have been established, the weighting being lower if said contact was not detected to have been established.

In embodiments, the connection request may disclose the identity of the querying user to the selected answering user.

In embodiments, the question may comprise an anonymised indication of the querying user, such that the identity of the querying user is not disclosed to the plurality of users during said distributing of the question.

In embodiments, the question may comprise an anonymised indication of the querying user, such that the identity of the querying user is not disclosed to the plurality of users during said distributing of question; but wherein the connection request may disclose the identity of the querying user to the selected answering user.

In embodiments, the code may be configured so as when run on the processing apparatus to analyse the question to extract one or more aspects of the question, and to select said set of users to whom the question is distributed based on a comparison of the extracted aspects of the question with the profiles of the plurality of users, wherein said set consists of fewer than said plurality of users.

In some such embodiments, the selection of said set may be further based on the similarity between a profile of the querying user and the respective user profiles of each of the plurality of users.

In embodiments, the code may be configured so as when run on the processing apparatus to distribute the question to the set of users from amongst other questions received from other querying users in a question list, wherein the questions in the question list are ranked based on a similarity between respective user profiles of the querying users and the respective profiles of said set of users.

In embodiments, the code may be configured so as when run on the processing apparatus to analyse the question to extract one or more aspects of the question, and to distribute the question to the set of users from amongst other questions received from other querying users in a question list based on matching the extracted aspects of the question with the user profiles of each of said set of users.

In embodiments, the code may be configured so as when run on the processing apparatus to return to the querying user other questions in the database submitted by other querying users, wherein the other questions are similar to the question submitted by the querying user.

In embodiments, said dependency on said further contact may be applied only if the rating given by the querying exceeds a threshold, but not otherwise.

In embodiments, the rating may contribute to the feedback score of the selected answering user with a weighting that depends on one or more of: a status of the selected answering user, a status of the querying user, and/or a degree of footfall sensed within a predetermined proximity of the selected answering user by one or more presence sensors.

In embodiments, the code may be configured to delay the distribution of said question to one or more of said set of users and/or to delay return of the answers from one or more of said set of users in dependence on one or both of: a respective status of the user of said set, and/or a degree of footfall sensed within a predetermined proximity of the user of said set by one or more presence sensors.

According to another aspect disclosed herein, there is provided a system comprising: a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user; memory comprising one or more memory units, said memory storing code; a processing apparatus comprising one or more processing units, said processing apparatus being arranged to run said code; wherein the code is configured so as when run on the processing apparatus to perform operations of: receiving a question from a querying user; distributing the question to a set of some or all of said plurality of users; in response to the question, receiving answers from multiple answering users from amongst said set of users; returning to the querying user the answers and user profiles of at least some of the answering users, wherein the returned answers and user profiles are returned to the querying user in a form ranked according to the respective feedback scores of the answering users; receiving a connection request from the querying user addressed to a selected one of the answering users, and forwarding the connection request to the selected answering user in order to request establishment of further contact between the querying user and the selected answering user; detecting whether the further contact has been established between the querying user and the selected answering user following the forwarding of said connection request; and receiving a rating from the querying user in relation to the selected answering user; wherein a contribution of the querying user's rating toward the respective feedback score of the selected answering user is dependent on the detection that said further contact was established.

In embodiments the method may further comprise steps in accordance with any embodiments of the system disclosed herein.

According to another aspect disclosed herein, there is provided computer program product comprising code embodied on computer readable storages and configured so as when run on a processing apparatus comprising one or more processing units to perform operations of: accessing a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user; receiving a question from a querying user; distributing the question to said plurality of users; in response to the question, receiving answers from multiple answering users from amongst said plurality of users; returning to the querying user the answers and user profiles of at least some of the answering users, wherein the returned answers and user profiles are returned to the querying user in a form ranked according to the respective feedback scores of the answering users; receiving a connection request from the querying user addressed to a selected one of the answering users, and forwarding the connection request to the selected answering user in order to request establishment of further contact between the querying user and the selected answering user; detecting whether the further contact has been established between the querying user and the selected answering user following the forwarding of said connection request; and receiving a rating from the querying user in relation to the selected answering user; wherein a contribution of the querying user's rating toward the respective feedback score of the selected answering user is dependent on the detection that said further contact was established.

In embodiments, the code may be further configured to perform operations in accordance with any of the system features disclosed herein.

Other variants and/or applications of the disclosed techniques may become apparent to a skilled person once given the disclosure herein. The scope of the present disclosure is not limited by the above-described embodiments but only by the accompanying claims.

1. A system comprising:
a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user;
memory comprising one or more memory units, said memory storing code;
a processing apparatus comprising one or more processing units, said processing apparatus being arranged to run said code; wherein the code is configured so as when run on the processing apparatus to perform operations of:
receiving a question from a querying user;
distributing the question to a set of some or all of said plurality of users;
in response to the question, receiving answers from multiple answering users from amongst said set of users;
returning to the querying user the answers and user profiles of at least some of the answering users, wherein the returned answers and user profiles are returned to the querying user in a form ranked according to the respective feedback scores of the answering users;
receiving a connection request from the querying user addressed to a selected one of the answering users, and forwarding the connection request to the selected answering user in order to request establishment of further contact between the querying user and the selected answering user;
detecting whether the further contact has been established between the querying user and the selected answering user following the forwarding of said connection request; and
receiving a rating from the querying user in relation to the selected answering user;
wherein a contribution of the querying user's rating toward the respective feedback score of the selected answering user is dependent on the detection that said further contact was established.

2. The system of claim 1, wherein the system comprises one or more proximity detection devices for detecting proximity between users, wherein said further contact comprises a physical meeting between the querying user and the selected answering user, and wherein the detection that said further contact has been established comprises receiving an input from the one or more proximity detection devices confirming that the querying user has come within a predetermined proximity of a location of the selected answering user or vice versa.

3. The system of claim 2, wherein one or more of:
the one or more proximity detection devices comprise at least one near-field communication device configured to detect said proximity based on a near field communication technology,
the one or more proximity devices comprise at least one RF reader configured to detect said proximity based on reading an RF tag,
the one or more proximity devices comprise at least one barcode scanning device configured to detect said proximity based on scanning a 1D or 2D barcode,
the one or more proximity devices comprise at least one biometric scanner configured to detect said proximity based on scanning at least one biometric feature of the querying user or selected answering user,
the one or more proximity devices comprise at least one manual user input device configured to detect said proximity based on the querying user or selected answering user having to manually input a code at the manual user input device, and/or
the one or more proximity devices comprise at least one mobile device configured to detect said proximity based on detecting a location of the mobile device relative to a network of wireless reference nodes.

4. The system of claim 1, wherein said further contact comprises a virtual meeting, and wherein said detection is performed by acquiring digital signatures from the querying user and/or the target user.

5. The system of claim 4, wherein the virtual meeting comprises a voice or video call, and said detection comprises detecting that the voice or video call has been established.

6. The system of claim 1, wherein the contribution of the rating to the respective feedback score of the selected answering user is dependent on the detection that said contact was established in that:
the rating only contributes to the feedback score of the selected answering user on condition that said contact is detected to have been established.

7. The system of claim 1, wherein the contribution of the rating to the respective feedback score of the selected answering user is dependent on the detection that said contact was established in that:
the rating contributes to the feedback score of the selected answering user with a weighting that depends on whether or not said contact is detected to have been established, the weighting being lower if said contact was not detected to have been established.

8. The system of claim 1, wherein the connection request discloses the identity of the querying user to the selected answering user.

9. The system of claim 1, wherein the question comprises an anonymised indication of the querying user, such that the identity of the querying user is not disclosed to the plurality of users during said distributing of the question.

10. The system of claim 8, wherein the question comprises an anonymised indication of the querying user, such that the identity of the querying user is not disclosed to the plurality of users during said distributing of question; but wherein the connection request discloses the identity of the querying user to the selected answering user.

11. The system of claim 1, wherein the code is configured so as when run on the processing apparatus to analyse the question to extract one or more aspects of the question, and to select said set of users to whom the question is distributed based on a comparison of the extracted aspects of the question with the profiles of the plurality of users, wherein said set consists of fewer than said plurality of users.

12. The system of claim 11, wherein the selection of said set is further based on the similarity between a profile of the querying user and the respective user profiles of each of the plurality of users.

13. The system of claim 1, wherein the code is configured so as when run on the processing apparatus to distribute the question to the set of users from amongst other questions received from other querying users in a question list, wherein the questions in the question list are ranked based on a similarity between respective user profiles of the querying users and the respective profiles of said set of users.

14. The system of claim 1, wherein the code is configured so as when run on the processing apparatus to analyse the question to extract one or more aspects of the question, and to distribute the question to the set of users from amongst other questions received from other querying users in a question list based on matching the extracted aspects of the question with the user profiles of each of said set of users.

15. The system of claim 1, wherein the code is configured so as when run on the processing apparatus to return to the querying user other questions in the database submitted by other querying users, wherein the other questions are similar to the question submitted by the querying user.

16. The system of claim 1, wherein said dependency on said further contact is applied only if the rating given by the querying exceeds a threshold, but not otherwise.

17. The system of claim 1, wherein the rating contributes to the feedback score of the selected answering user with a weighting that depends on one or more of:
a status of the selected answering user,
a status of the querying user, and/or
a degree of footfall sensed within a predetermined proximity of the selected answering user by one or more presence sensors.

18. The system of claim 1, the code is configured to delay the distribution of said question to one or more of said set of users and/or to delay return of the answers from one or more of said set of users in dependence on one or both of:
a respective status of the user of said set, and/or
a degree of footfall sensed within a predetermined proximity of the user of said set by one or more presence sensors.

19. A method comprising:
accessing a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user;
receiving a question from a querying user;
distributing the question to said plurality of users;
in response to the question, receiving answers from multiple answering users from amongst said plurality of users;
returning to the querying user the answers and user profiles of at least some of the answering users, wherein the returned answers and user profiles are returned to the querying user in a form ranked according to the respective feedback scores of the answering users;
receiving a connection request from the querying user addressed to a selected one of the answering users, and forwarding the connection request to the selected answering user in order to request establishment of further contact between the querying user and the selected answering user;
detecting whether the further contact has been established between the querying user and the selected answering user following the forwarding of said connection request; and
receiving a rating from the querying user in relation to the selected answering user;
wherein a contribution of the querying user's rating toward the respective feedback score of the selected answering user is dependent on the detection that said further contact was established.

20. A computer program product comprising code embodied on computer readable storages and configured so as when run on a processing apparatus comprising one or more processing units to perform operations of:
accessing a database comprising a set of user profiles, wherein each of the user profiles relates to a respective one of a plurality of users and includes a respective feedback score for the respective user, and wherein each respective feedback score is a running feedback score based on multiple past user feedback ratings relating to the respective user;
receiving a question from a querying user;
distributing the question to said plurality of users;
in response to the question, receiving answers from multiple answering users from amongst said plurality of users;
returning to the querying user the answers and user profiles of at least some of the answering users, wherein the returned answers and user profiles are returned to the querying user in a form ranked according to the respective feedback scores of the answering users;
receiving a connection request from the querying user addressed to a selected one of the answering users, and forwarding the connection request to the selected answering user in order to request establishment of further contact between the querying user and the selected answering user;
detecting whether the further contact has been established between the querying user and the selected answering user following the forwarding of said connection request; and
receiving a rating from the querying user in relation to the selected answering user;
wherein a contribution of the querying user's rating toward the respective feedback score of the selected answering user is dependent on the detection that said further contact was established.
